(19) United States
(12) Patent Application Publication
(10) Pub. No.: US 2014/0092366 A1
(43) Pub. Date: Apr. 3, 2014

(54) MULTI-PROJECTION SYSTEM AND DISPLAY SYSTEM USING THE SAME

(71) Applicant: YOUNG OPTICS INC., Hsinchu (TW)

(72) Inventors: Yi-Hsueh Chen, Hsinchu (TW); Chao Shun Chen, Hsinchu (TW)

(73) Assignee: YOUNG OPTICS INC., Hsinchu (TW)

(21) Appl. No.: 13/629,719

(22) Filed: Sep. 28, 2012

(51) Int. Cl. G03B 21/14

(52) U.S. Cl. 353/20

(57) ABSTRACT

A multi-projection system and a display system using the same are provided. The multi-projection system for projecting a plurality of images included in a beam onto a screen includes a beam source providing the beam; an image splitter in proximity to the beam source and has a positive magnifying ratio; and an imaging device in proximity to the image splitter, wherein the beam passes through the image splitter and the imaging device to be projected onto the screen.

### FIELD

The present disclosure relates to a projection system and a display system using the projection system. More particularly, it relates to a multi-projection system and a display system using the same.

### BACKGROUND

In the state of the art, there are various architectures that have been made concerning a multi-projection display system, which is capable of combining a to series of multiple images which may be dependent on each other and are respectively projected from a single projector or a plurality of projectors onto a screen into one image or a seamless integral image, so as to construct the plurality of images as one upon displaying. Alternatively, the multi-projection display system can also display a plurality of images which are independent of each other and are respectively projected from a single or a plurality of projectors onto a screen, a set of screens or any target region.

In a conventional multi-projection display system, an optical engine equipped with an off-axis light valve is commonly required for providing a beam carrying with a plurality of images to be projected. Please referring to FIGS. 1(a) and FIG. 1(b), which are respectively a schematic diagram illustrating a conventional multi-projection display system in a top view on an x-y plane and a schematic diagram illustrating multiple images displayed on a display surface of a conventional off-axis light valve in an optical engine in a side view on a y-z plane.

The multi-projection display system 100 in FIG. 1(a) includes an optical engine (not shown) having an off-axis light valve 105 for generating a beam carrying with a plurality of images, a pair of X-type dichroic mirrors including a first mirror 101 and a second mirror 102, a pair of projecting mirrors including a third mirror 103 and a fourth mirror 104, and a screen 107. The off-axis light valve 105 is used for forming a beam 106 carrying two images, an image A appearing at the upper-half part in the beam 106 ahead of lens 110 and an image B appearing at the lower-half part in the beam 106 ahead of lens 110, which are respectively sourced at the upper-half region RA and at the lower-half region RB on the display surface on the off-axis light valve 105 as shown in FIG. 1(b). The first mirror 101 and the second mirror 102 are respectively utilized to split the image A from the image B by independently reflecting the upper-half part and the lower-half part of the beam 106 respectively to the third mirror 103 and the fourth mirror 104, whereby the plurality of images A and B in the beam 106 are split, so that the image A and the image B are respectively reflected to the third mirror 103 and the fourth mirror 104 and are finally shown on the screen 107, in which the first mirror 101 and third mirror 103 are arranged at the same upper level above the lower level where the second mirror 102 and fourth mirror 104 are arranged at the same lower level.

The off-axis light valve 105 as shown in detail in FIG. 1(b) has a mechanical central axis 108 and an upper display region RA and a lower display region RB for respectively displaying images A and B to be synthesized in cooperation with a back light as the beam 106 carrying with multiple images A and B. The beam 106 propagates through the lens 111 to be terminally displayed on the screen 107. Each of which the upper display region RA and a lower display region RB has a light axis 109 and a light axis 110 offset from the mechanical central axis 108. The off-axis light valve 105 is usually an image micro-display unit or a light processing unit, utilizing several latest micro-display chips or digital light processing technologies respectively, for example, a digital micro-mirror device (DMD) chip, a liquid-crystal-on-silicon (LCoS) chip and a transmissive liquid crystal display (LCD) chip.

The image A and B will finally be combined into one integral image and shown on the screen 107 as they are dependent on each other by the multi-projection display system. In order to precisely combine the dual image A and B, the image A and B shall be aligned with each other on both horizontal and vertical directions on the screen 107. However, due to the off-axis optical valve introduced in the multi-projection display system, the beam 106 emitted out of the off-axis light valve 105 essentially has an optical angle relatively larger than that of an ordinary non-off-axis or coaxial optical system, which causes that, for ensuing the horizontal and vertical alignments for the images A and B, each of the mirrors 101, 102, 103 and 104 shall have bi-dimension tilts and require to be disposed as far as possible away from the off-axis light valve 105, which results in an increase on overall width or height, vice versa, for the multi-projection display system.

In view of the drawbacks of prior arts, there is a need to solve the above deficiencies/problems.

### SUMMARY

The present invention provides an architecture for a multi-projection display system, which is also referred to as a multi-display projection system, and a display system using the architecture. The proposed architecture for a multi-projection display system has a relatively thin thickness or small width for the overall system as compared with the same system in the prior art.

In accordance with one aspect of the present disclosure, a display system for a projection of a plurality of images included in a beam onto a screen includes a light valve providing the beam; an image splitter optically coupled to the light valve and having a first optical axis and a positive magnification; and an optical imaging device optically coupled to the image splitter and having a second optical axis free from being coaxial with the first optical axis, wherein the beam from the light valve passes through the image splitter and the optical imaging device to be projected onto the screen.

In accordance with one aspect of the present disclosure, a projecting system for projecting a plurality of images included in a beam onto a screen includes a beam source providing the beam; an image splitter in proximity to the beam source and has a positive magnifying ratio; and an imaging device in proximity to the image splitter, wherein the beam passes through the image splitter and the imaging device to be projected onto the screen.

In accordance with one aspect of the present disclosure, a projecting system for projecting a plurality of images included in a beam from a beam source onto a screen includes an image splitter between the beam source and the screen and having a positive magnification.

The present disclosure may best be understood through the following descriptions with reference to the accompanying drawings, in which:

### DESCRIPTION OF THE DRAWINGS

FIG. 1(a) is a schematic diagram illustrating a conventional multi-projection display system in a top view on an x-y plane.

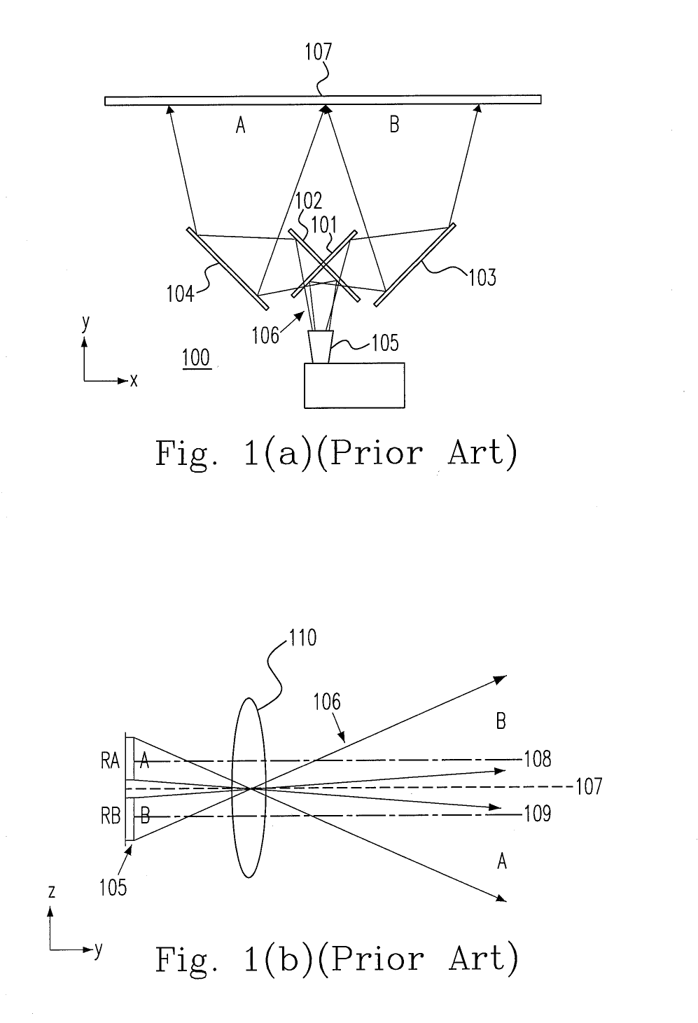

FIG. 1(b) is a schematic diagram illustrating multiple images shown on a display surface of a conventional off-axis light valve in a side view on a y-z plane.

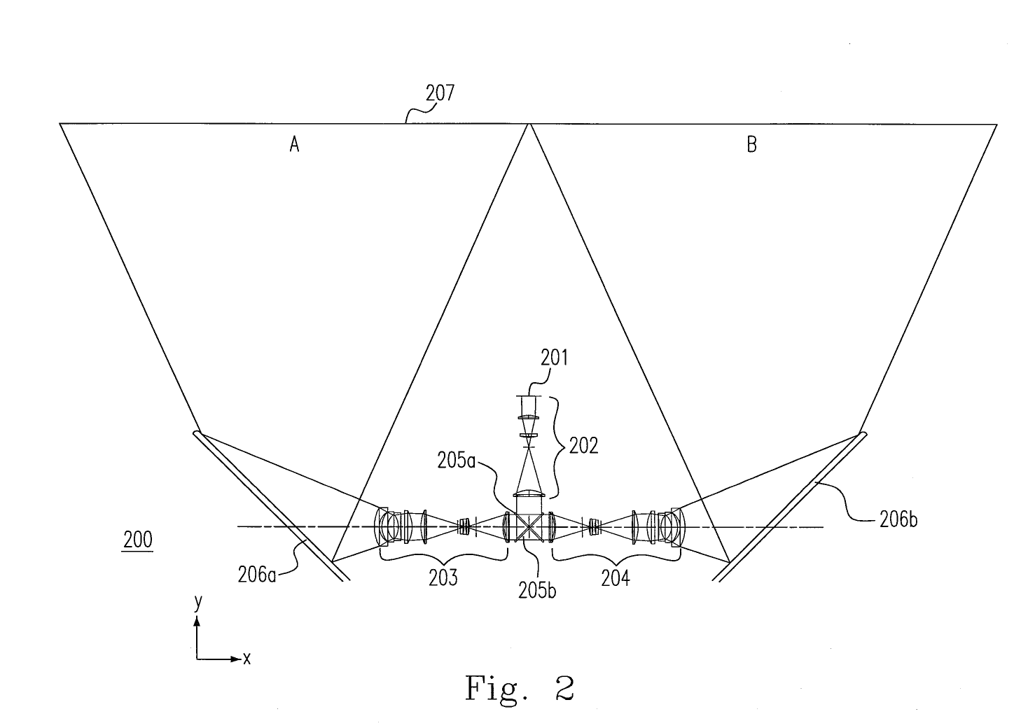

FIG. 2 is a schematic diagram illustrating a multi-projection display system in a top view on an x-y plane in accordance with the present invention.

FIGS. 3(a) and 3(b) are schematic diagrams respectively illustrating a horizontally-arranged-type off-axis light valve and a vertically-arranged-type off-axis light valve in a front view on an y-z plane in accordance with the present invention.

FIG. 4 is a schematic diagram illustrating a structure for an image splitter in a side view on a y-z plane in accordance with the present invention.

FIGS. 5(a), 5(b) and 5(c) are schematic diagrams illustrating an exemplary configuration between the image splitter and the optical imaging device in a top view on an x-y plane in accordance with the present invention.

FIGS. 6(a) and 6(b) are schematic diagrams illustrating an in-coaxial configuration mode for optically coupling the image splitter and the optical imaging device in a side view on a y-z plane in accordance with the present invention.

FIG. 7 is a schematic diagram illustrating the multi-projection display system equipped with a light integration rod in accordance with the present invention.

### DETAILED DESCRIPTION

The present invention will be described with respect to particular embodiments and with reference to certain drawings, but the invention is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Moreover, the terms top, bottom, up, low, over, under and the like in the description and the claims are used for descriptive purposes and not necessarily for describing relative positions. It is to be understood that the terms so used are interchangeable under appropriate circumstances and that the embodiments described herein are capable of operation in other orientations than described or illustrated herein.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this invention, in one or more embodiments.

Similarly it should be appreciated that in the description of exemplary embodiments, various features are sometimes grouped together in a single embodiment, figure, or description thereof for the purpose of streamlining the invention and aiding in the understanding of one or more of the various inventive aspects. This method of invention, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments may be practiced without these specific details. In other instances, well-known methods, structures and techniques have not been shown in detail in order not to obscure an understanding of this description.

The invention will now be described by a detailed description of several embodiments. It is clear that other embodiments can be configured according to the knowledge of persons skilled in the art without departing from the true technical teaching of the present invention, the claimed invention being limited only by the terms of the appended claims.

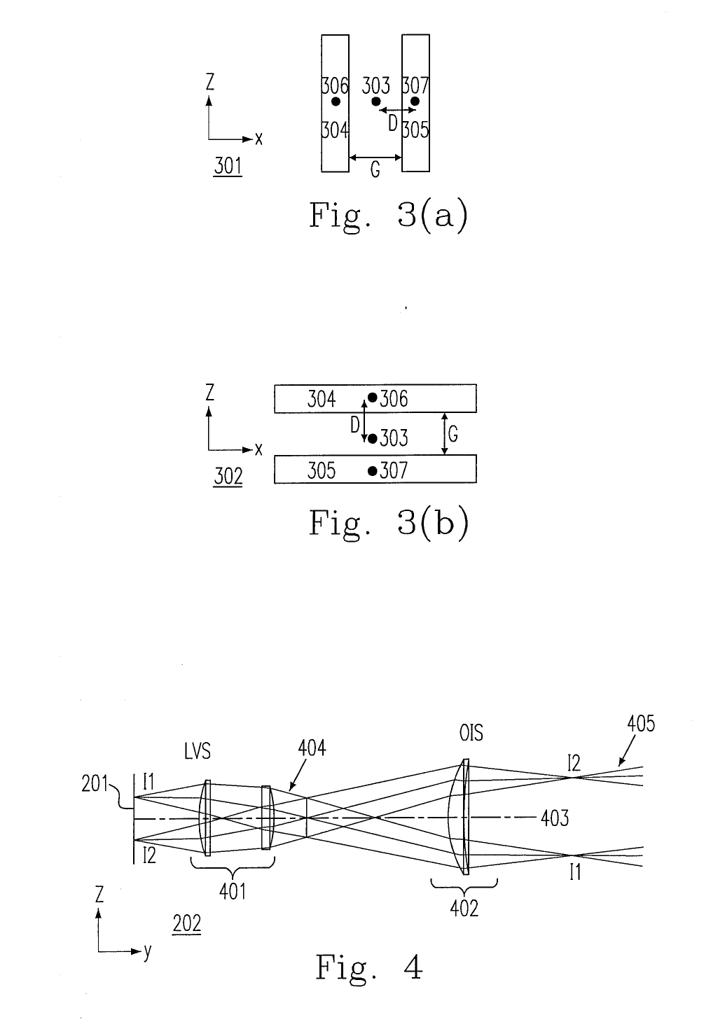

FIG. 2 is a schematic diagram illustrating a multi-projection display system in a top view on an x-y plane in accordance with the present invention. The multi-projection display system 200 in FIG. 2 is a display system for displaying digital media information with a projection of a plurality of images included in a beam onto a screen 207 and includes a light valve 201, an image splitter 202, optical imaging devices 203 and 204 (also referred to as a secondary imaging device or a projecting device), a set of dividing reflective elements 205 and a set of projecting reflective elements 206, wherein the set of dividing reflective elements 205 includes dual dichroic mirrors 205a and 205b up-down cross with each other and the set of projecting reflective elements 206 includes dual mirrors 206a and 206b which are preferably configured symmetrically.

In one embodiment, the multi-projection display system 200 includes a multi-projection core. The multi-projection core includes the light valve 201, the image splitter 202, the optical imaging devices 203 and 204, the set of dividing reflective elements 205 and the set of projecting reflective elements 206. Certainly, the multi-projection core plus the screen 207 accordingly form the multi-projection display system 200. The multi-projection display system 200 is preferably a rear projection based display system, and in one embodiment the multi-projection display system 200 is a front projection based display system.

The image splitter 202 is optically coupled with and between the light valve 201 and the optical imaging devices 203 and 204 and receives a beam that carries a plurality of images and is generated by the light valve 201. The plurality of images can be independent of each other or dependent on each other. The image splitter 202 is functioned to split the plurality of the images in the beam into such a status that the plurality of the images does not overlap with each other in the beam and transmit the image-split beam to the set of dividing reflective elements 205. Upper mirror 205a and lower mirror 205b in the set of dividing reflective elements 205 are designed to divide the image-split beam into a plurality of divided beams subject to the maintenance of the individual integrity for each of the plurality of images. At the same time, each mirrors 205a and 205b further directs one of the to divided beams carrying an integral image of the plurality of images into one of the optical imaging devices 203 and 204. Each of the optical imaging devices 203 and 204 provides functions regarding off-axis compensation, zooming, chromatic aberration and error eliminating, projecting and focusing adjustments to the divided beams and then transmits the adjusted beams to the set of projecting reflective elements 206 by which the adjusted beams are projected onto the screen 207. Eventually, each of the integral images carried in the adjusted beams are respectively displayed on different region of the screen 207.

The multi-projection display system 200 further includes a light source. The light source is preferably an ultra high pressure (UHP) lamp, a light emitting diode, a laser and is functioned to provide a light. The light valve 201 is functioned as a image display unit or a light processing unit to process the plurality of images to be associated with the light in cooperation with the light source so as to form the beam including the plurality of images and is preferably a digital micro-mirror display (DMD) chip, a liquid-crystal-on-silicon (LCoS) chip and a transmissive liquid crystal display (LCD) chip. While the light valve 201 is a DMD chip, there is a color wheel selectively disposed between the light source and the light valve. Accordingly, the light emitting from the light source may be transformed into the beam carrying with the plurality of images after passing through the light valve, and the light valve 201 is capable of providing a beam carrying with a plurality of images.

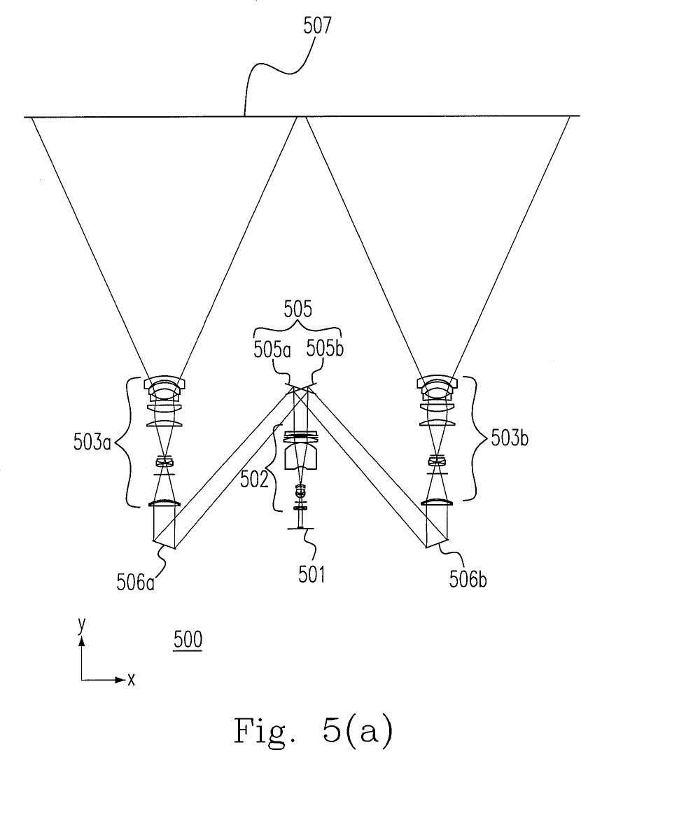

In one embodiment, the light valve 201 is preferably an off-axis light valve for providing the plurality of images. FIGS. 3(a) and 3(b) are schematic diagrams respectively illustrating a horizontally-arranged-type off-axis light valve and a vertically-arranged-type off-axis light valve in a front view on an y-z plane in accordance with the present invention. There are two types of the off-axis light valve, a horizontally-arranged-type off-axis light valve 301 and a vertically-arranged-type off-axis light valve 302 respectively shown in FIGS. 3(a) and 3(b), taken as exemplary embodiments to illustrate the off-axis light valve to be involved in the present invention. In FIGS. 3(a) and 3(b), the off-axis light valves 301 and 302 have a mechanical central axis 303 and may provide multiple images 304 and 305, each of which multiple images 304 and 305 are separated apart from each other with a distance of gap G. The multiple images 304 and 305 have a light axis 306 and a light axis 307 respectively, each of which light axes 306 and 307 is offset from the mechanical central axis 301 with a distance of an offset displacement D. The multiple images 304 and 305 may be provided by the same one micro-display chip or multiple different micro-display chips, which means that the off-axis light valve 302 (a.k.a. the light valve 201) may be fabricated with single one chip, or two or more chips.

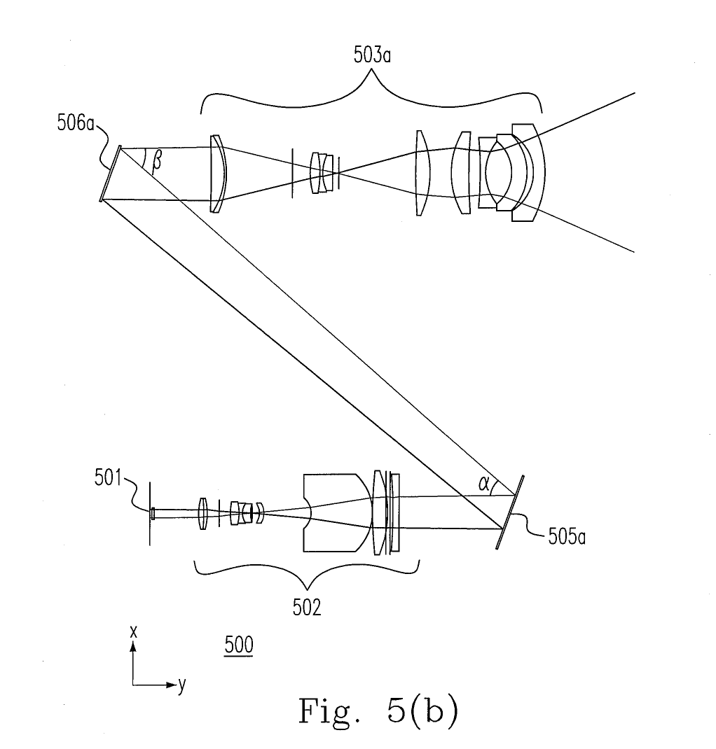

FIG. 4 is a schematic diagram illustrating a structure for an image splitter in a side view on a y-z plane in accordance with the present invention. The image splitter 202 in FIG. 4 has a first optical axis 403 and includes a first lens group 401 disposed at a light valve side LVS which is a side toward the light valve 201 and a second lens group 402 disposed at an optical imaging device side OIS which is a side toward to the optical imaging devices 203 and 204. The first lens group 401 is selected from a group consisting of a positive lens, a negative lens and a combination thereof and is functioned to perform a first convergence of the beam 404 and split the plurality of the images I1 and I2 in the beam 404 into such a status that the plurality of the images I1 and I2 do not overlap with each other in the beam. The second lens group 402 is also selected from a group consisting of a positive lens, a negative lens and a combination thereof and is functioned receive the image-split beam passing through the first lens group 401 and to perform a secondary convergence to the image-split beam. The first lens group 401 and the second lens group 402 are coaxially configured on the first optical axis 403. Eventually when the incident beam 404 leaves the image splitter 202 as an exiting beam, the plurality of images included in the exiting beam 405 are spilt and do not overlap with each other.

In brief, the image splitter 202 includes but not limited to one or multiple lens groups which include a positive lens, a negative lens or a series of positive and negative lens to provide a positive magnifying ratio and to split the plurality of images in the beam. The positive magnifying ratio is also known as a positive magnification which is preferably in a range from zero to infinite, or preferably in a range from 1.0 to 3.0. In one embodiment, the image splitter 202 can only include one lens which can be a positive or an negative lens as long as it is capable of causing a positive magnification to the beam preferably in a range from 1.0 to 3.0 and splitting the plurality of images in the beam. Hence, the exiting beam or the image-split beam 405 to be entered to the optical imaging devices 203 and 204 correspondingly possesses a relatively small optical angle as the image splitter 202 has the positive magnification, in subject to an Étendue optical invariant theory.

Subsequently, the image-split beam 405 is then transmitted to the set of dividing reflective elements 205. A pair of upper mirror 205a and lower mirror 205b in the set 205 are configured horizontally up-down cross with each other in which the upper mirror 205a crosses the lower mirror 205b and do or do not physically intersect. The pair of mirrors 205a and 205b are arranged to receive the image-split beam 405 and divide it into a plurality of divided beams subject to a condition that each of the divided beams just carries one complete image of the plurality of images.

Each of the optical imaging devices 203 and 204 has a second optical axis and is designed to provide appropriate off-axis compensation, zooming, chromatic aberration and error eliminating, projecting and focusing adjustments to each of the divided beams transmitted from each of the pair of mirrors 205a and 205b. The adjusted beams propagate to the pair of mirrors 206a and 206b to be projected onto the screen 207 thereby.

Eventually, each of the integral image of the multiple off-axis images 304 and 305 that are vertically arranged in a vertically-arranged-type off-axis light valve 302 as shown in FIG. 3(b), which can be independent of or dependent on each other, sourced from the light valve 201 and carried in the plurality of image-split, divided and adjusted beams is finally projected onto the screen 207 and well combined together on the screen 207 in a horizontally stitching projection mode, in which the set of dividing reflective elements 205 are horizontally up-down cross with each other, and the optical imaging devices 203 and 204 and the set of projecting reflective elements 206 are all arranged in horizontal.

In one embodiment, each of the integral image of the multiple off-axis images 304 and 305 that are horizontally arranged in a horizontally-arranged-type off-axis light valve 301 as shown in FIG. 3(a) sourced from the light valve 201 is finally projected onto the screen 207 and well combined on the screen 207 in a vertically stitching projection mode, in which the set of dividing reflective elements 205 are vertically left-right cross with each other, and the optical imaging devices 203 and 204 and the set of projecting reflective elements 206 are all arranged in vertical.

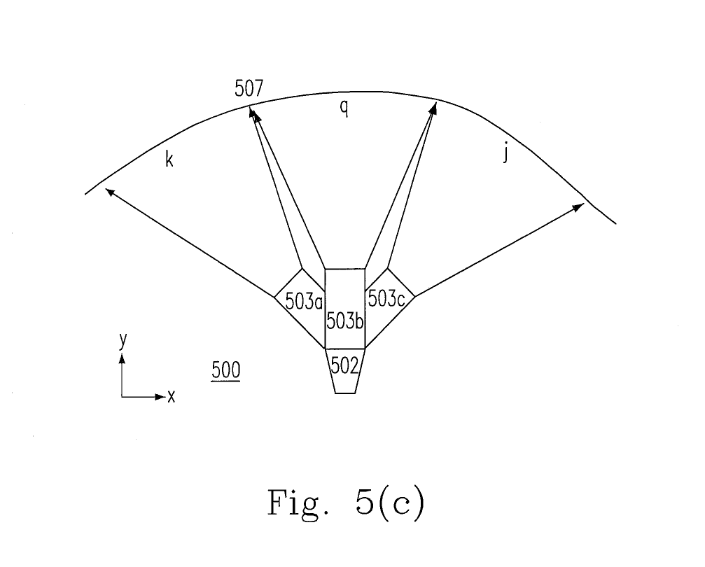

In one embodiment, the image splitter and the optical imaging device can be optically coupled with each other in more diverse configurations, as long as the coupled relationship between the image splitter and the optical imaging device is preferably subject to the condition that the respective optical axes for the image splitter and the optical imaging device are in-coaxial. FIGS. 5(a), 5(b) and 5(c) are schematic diagrams illustrating an exemplary configuration between the image splitter and the optical imaging device in a top view on an x-y plane in accordance with the present invention. FIG. 5(a) shows a multiple projection display system 500, and as shown in FIG. 5(b), there are a cross-point angle α existing between the upper mirror 505a and the lower mirror 505b in the a set of dividing reflective elements 500 at the cross-point location where the upper mirror 505a crosses the lower mirror 505b and a reflective angle β between an incident beam and a reflected beam for the mirror 506a. The magnitudes for angles α and β can be freely adjusted as long as the respective optical axes for the image splitter 502 and the imaging devices 503a and 503b are preferably in-coaxial such that the image splitter 502 and the imaging devices 503a and 503b can be optically coupled with each other in more diverse configurations, for example, an exemplarily configuration as shown in FIGS. 5(a) and 5(b). Certainly, in a few of embodiments, the optical axes for the image splitter and the imaging device can be coaxially arranged as well.

Moreover, although the condition that there are merely two images formed in a single beam is described in the preceding embodiments, in practice, single image splitter 502 can split images more than two carried in a single beam as well. In FIG. 5(c), a single image splitter 502 splits three images k, q, j carried in a single beam emitted from an off-axis light valve 501 and this single image splitter 502 is optically coupled with three imaging devices 503a, 503b and 503c. The imaging devices 503a, 503b and 503c projects the three images k, q, j onto a set of surrounded screens 507 to create a full-view-like theater effect.

In order to compensate and adjust the horizontal offset deviation resulted from the gap between images on the off-axis light valve, for example the vertical gap G existing in the vertically-arranged-type off-axis light valve as shown in FIG. 3(b), for each of the projected images, for horizontally aligning the plurality of projected images with each other on the screen, at the same time without increasing overall height to the multi-projection core, the optical axes for the image splitter and the imaging devices are preferably arranged in an in-coaxial configuration mode, in which, the first optical axis of the image splitter 502 and each of the second optical axes of the imaging devices 503a, 503b and 503c are offset from each other.

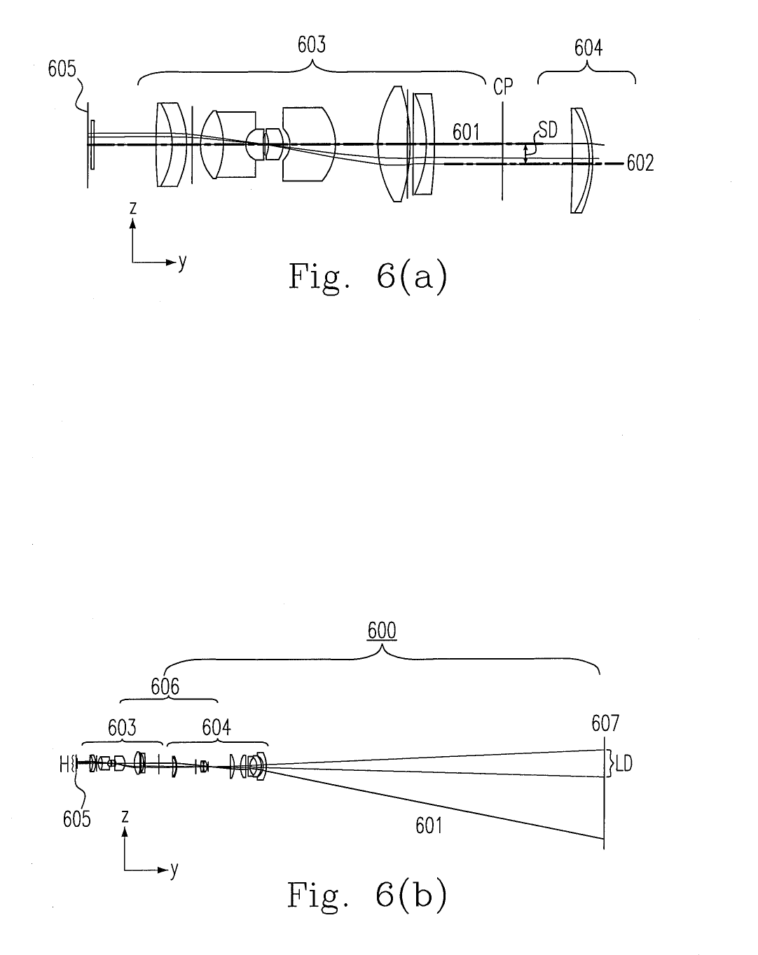

FIGS. 6(a) and 6(b) are schematic diagrams illustrating an in-coaxial configuration mode for optically coupling the image splitter and the optical imaging devices in a side view on a y-z plane in accordance with the present invention. Since even though an extremely slight displacement SD is set between the first optical axis 601 and the second optical axis 602 at the optically coupled position CP of the image splitter 603 and the optical imaging device 604, it can cause sufficient large displacement LD for the specific projected image displayed on the screen 607 to correspondingly correct the offset deviation to the projected image resulted from gap between images on the off-axis light valve 605. Therefore, the image splitter 603 and the optical imaging device 604 are in-coaxially arranged to set a suitable offset displacement SD between the first and second optical axes 601 and 602 so as to compensate the horizontal offset for image or adjust the horizontal position for the projected images displayed on the screen 607, whereby the overall height H, namely the thickness, for the multi-projection core 606 can be correspondingly decreased as well. The multi-projection display system 600 includes the multi-projection core 606 and the screen 607.

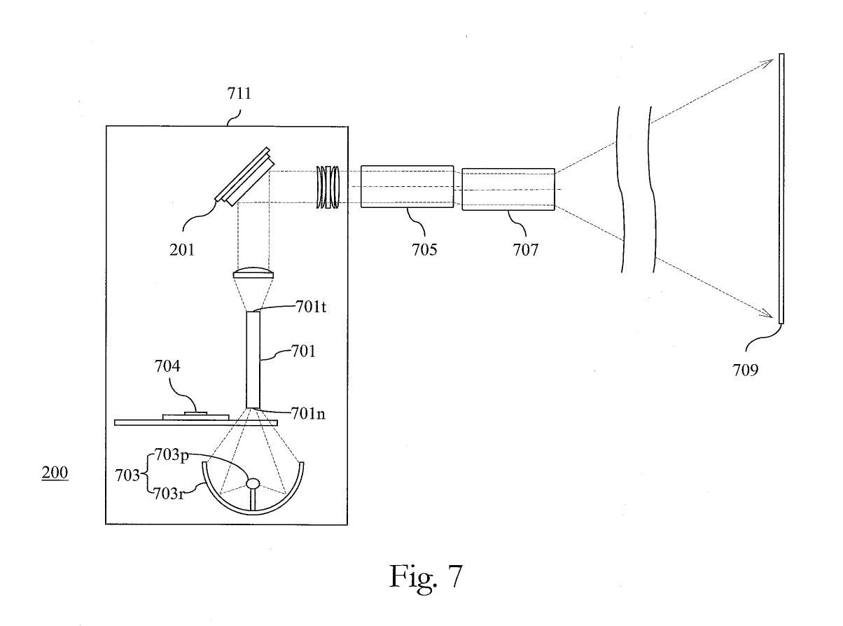

For further improving the magnification for the image splitter, it is a feasible scheme to minimize or suppress it to be as small as possible the optical angle for the incident beam emitted from the light valve entering into the image splitter. Thus, a light integration rod can be further employed as a component in the multi-projection display system 200 in the present invention. A digital light processing technology architecture is exemplarily employed in this embodiment. FIG. 7 is a schematic diagram illustrating the multi-projection display system equipped with a light integration rod in accordance with the present invention. In FIG. 7, the multi-projection display system 200 includes a beam source (also referred to as an optical engine) 711, an image splitter 705, an optical imaging device 707 and a screen 709. The beam source 711 mainly includes the light source 703, the light integration rod 701 and the light valve 201. While the light valve 201 is digital light processing technology, for example a DMD chip, a color wheel 704 is selectively disposed between the light source 703 and the light valve 201 and additionally involved in the beam source 711.

The light source 703 consists of a lamp 703p and a reflective cover 703r and the light integration rod 701 has a light entering end 701n and a light exiting end 701t. The light source 703, the light integration rod 701 and the light valve 201 are such configured that the light emitted from the light source 703 passes through the light integration rod 701 by entering it from the light entering end 701n and exiting it from the light exiting end 701t and propagates to the light valve 201 to form the beam. The integration rod 701 is functioned to integrate and uniform the light and is capable of causing an elliptic optical angle to the light which correspondingly minimizes the overall optical angle for the beam entering into the image splitter 705 at the same time so that the beam entering into the image splitter 705 has a relatively small optical angle.

The multi-projection display system in the present invention is particularly designed to have image splitter with a positive magnification to be as large as possible and a light valve capable of providing an elliptic optical angle for an incident beam entering into the image splitter. In accordance with the Étendue theory describing an optical invariant law, it is known that in a specific imaging system, an Étendue quantity for a light cone must be invariant on its propagation route from a point P to a point P′ and obey the Étendue optical invariant law as following formula (I):

E=π×A×sin²(θ)=π×A′×sin²(θ′) Formula (1),

wherein A represents an area or also a magnification for point P, A′ represents an area or also a magnification for point P′, 0 represents an optical angle at point P and θ′ represents an optical angle at point P′.

With subject to the above-mentioned Étendue invariant theory, as the magnification A in the image splitter can be maximized, the optical angle θ is correspondingly minimized, and vice versa. Accordingly, the present invention provides an image splitter which has a positive magnification to be as large as possible, and an off-axis light valve in cooperation with a light integration rod which can generate an incident beam entering into the image splitter in an elliptic optical angle to be as small as possible.

Owing to the above-mentioned image splitter and light valve introduced, the overall thickness or width for the multi-projection display system can be significantly reduced. The multi-projection display system in the present invention owns a thin thickness or a small width as compared with the same system in the prior art and complies with the thinning tendency and demands for the consuming electronic devices on the current market.

There are further embodiments provided as follows.

### Embodiment 1

A display system for a projection of a plurality of images included in a beam onto a screen includes a light valve providing the beam; an image splitter optically coupled to the light valve and having a first optical axis and a positive magnification; and an optical imaging device optically coupled to the image splitter and having a second optical axis free from being coaxial with the first optical axis, wherein the beam from the light valve passes through the image splitter and the optical imaging device to be projected onto the screen.

### Embodiment 2

The display system according to the preceding embodiment, wherein the positive magnification is in a range from 1.0 to 3.0.

### Embodiment 3

The display system according to the preceding embodiments further includes a light source providing a light and a light integration rod with a light entering surface and a light exiting surface, wherein the light source is one selected from a group consisting of a lamp, a light emitting diode, a laser and a combination thereof.

### Embodiment 4

The display system according to the preceding embodiments, wherein the light source, the light integration rod and the light valve are such configured that the light emitted from the light source passes through the light integration rod by entering it from the light entering surface and exiting it from the light exiting surface and propagates to the light valve, and the light integration rod is functioned to integrate and uniform the light and to cause the light to be in an elliptic optical angle so that the beam entering into the image splitter has a relatively small optical angle.

### Embodiment 5

The display system according to the preceding embodiments, wherein the light valve is one selected from a group consisting of a digital micro-mirror display chip, a liquid-crystal-on-silicon chip and a transmissive liquid crystal display chip and is functioned as one of a image display unit and a light processing unit to process the plurality of images to be associated with the light in cooperation with the light source and the integration rod so as to form the beam including the plurality of images.

### Embodiment 6

The display system according to the preceding embodiments, wherein the image splitter further includes a first lens group at a light valve side thereof toward the light valve and a second lens group at an optical imaging device side thereof toward the optical imaging device.

### Embodiment 7

The display system according to the preceding embodiments, wherein the first lens group is functioned to perform a first convergence of the beam and split the plurality of the images in the beam into such a status that the plurality of the images do not overlap with each other in the beam, and the second lens group is functioned to receive the beam and perform a second convergence of the beam.

### Embodiment 8

The display system according to the preceding embodiments, wherein the first lens group consists of a group selected from a positive lens, a negative lens and a combination thereof and the second lens group consists of a group selected from a positive lens, a negative lens and a combination thereof and coaxially configured on the first optical axis with the first lens group.

### Embodiment 9

The display system according to the preceding embodiments, wherein the beam entering into the optical imaging device has a relatively small optical angle as the image splitter has the positive magnification, in subject to an Étendue optical invariant theory.

### Embodiment 10

The display system according to the preceding embodiments, wherein the plurality of images are in one of a status that the plurality of images are independent of each other and a status that the plurality of images are dependent on each other.

### Embodiment 11

The display system according to the preceding embodiments, wherein there is an offset displacement between the first optical axis and the second optical axis.

### Embodiment 12

The display system according to the preceding embodiments, wherein there is a set of reflective elements between the image splitter and the optical imaging device to divide the beam from the image splitter into a plurality of divided beams and to direct the plurality of divided beams into respective optical imaging device.

### Embodiment 13

The display system according to Claim 1 being a rear projection based display device.

### Embodiment 14

A projecting system for projecting a plurality of images included in a beam onto a screen includes a beam source providing the beam; an image splitter in proximity to the beam source and has a positive magnifying ratio; and an imaging device in proximity to the image splitter, wherein the beam passes through the image splitter and the imaging device to be projected onto the screen.

### Embodiment 15

The projecting system according to the preceding embodiment, wherein the image splitter has a first optical axis and the image device has a second axis free from being coaxial with the first optical axis.

### Embodiment 16

The projecting system according to the preceding embodiments, wherein the beam source further includes a light source providing a light, a light integration rod having a light entering end and a light exiting end and a light valve, and the light source, the light integration rod and the light valve are such configured that the light emitted from the light source passes through the light integration rod by entering it from the light entering end and exiting it from the light exiting end and propagates to the light valve.

### Embodiment 17

The projecting system according to the preceding embodiments, wherein the light integration rod is functioned to integrate and uniform the light and to cause the light to be in an elliptic optical angle, and the light valve is one selected from a group consisting of a digital micro-mirror display chip, a liquid-crystal-on-silicon chip and a transmissive liquid crystal display chip and is functioned as a light processing unit to process the plurality of images to be associated with the light in cooperation with the light source and the integration rod so as to form the beam including the plurality of images.

### Embodiment 18

The projecting system according to the preceding embodiments, wherein the image splitter further includes a first lens group at a beam source side thereof toward the beam source and a second lens group at a imaging device side thereof toward the imaging device.

### Embodiment 19

The projecting system according to the preceding embodiments, wherein the first lens group is functioned to perform a first convergence of the beam and split the plurality of the images in the beam such that the plurality of the images do not overlap with each other in the beam, and the second lens group is functioned to receive the beam and perform a second convergence of the to beam.

### Embodiment 20

A projecting system for projecting a plurality of images included in a beam from a beam source onto a screen includes an image splitter between the beam source and the screen and having a positive magnification.

While the disclosure has been described in terms of what are presently considered to be the most practical and preferred embodiments, it is to be understood that the disclosure need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A display system for a projection of a plurality of images included in a beam onto a screen, comprising:
a light valve providing the beam;
an image splitter optically coupled to the light valve and having a first optical axis and a positive magnification; and
an optical imaging device optically coupled to the image splitter and having a second optical axis free from being coaxial with the first optical axis, wherein the beam from the light valve passes through the image splitter and the optical imaging device to be projected onto the screen.

2. The display system according to claim 1, wherein the positive magnification is in a range from 1.0 to 3.0.

3. The display system according to claim 1, further comprising a light source providing a light and a light integration rod with a light entering surface and a light exiting surface, wherein the light source is one selected from a group consisting of a lamp, a light emitting diode, a laser and a combination thereof.

4. The display system according to claim 3, wherein the light source, the light integration rod and the light valve are such configured that the light emitted from the light source passes through the light integration rod by entering it from the light entering surface and exiting it from the light exiting surface and propagates to the light valve to form the beam, and the light integration rod is functioned to integrate and uniform the light and to cause the light to be in an elliptic optical angle so that the beam entering into the image splitter has a relatively small optical angle.

5. The display system according to claim 3, wherein the light valve is one selected from a group consisting of a digital micro-mirror display chip, a liquid-crystal-on-silicon chip and a transmissive liquid crystal display chip and is functioned as one of a image display unit and a light processing unit to process the plurality of images to be associated with the light in cooperation with the light source and the integration rod so as to form the beam including the plurality of images.

6. The display system according to claim 1, wherein the image splitter further includes a first lens group at a light valve side thereof toward the light valve and a second lens group at an optical imaging device side thereof toward the optical imaging device.

7. The display system according to claim 6, wherein the first lens group is functioned to perform a first convergence of the beam and split the plurality of the images in the beam into such a status that the plurality of the images do not overlap with each other in the beam, and the second lens group is functioned to receive the beam and perform a second convergence of the beam.

8. The display system according to claim 6, wherein the first lens group consists of a group selected from a positive lens, a negative lens and a combination thereof and the second lens group consists of a group selected from a positive lens, a negative lens and a combination thereof and coaxially disposed on the first optical axis with the first lens group.

9. The display system according to claim 1, wherein the beam entering into optical imaging device correspondingly has a relatively small optical angle as the image splitter has the positive magnification, in subject to an Étendue optical invariant theory.

10. The display system according to claim 1, wherein the plurality of images are in one of a status that the plurality of images are independent of each other and a status that the plurality of images are dependent on each other.

11. The display system according to claim 1, wherein there is an offset displacement between the first optical axis and the second optical axis such that the image splitter and the optical imaging device are in-coaxially configured.

12. The display system according to claim 1, wherein there is a set of reflective elements between the image splitter and the optical imaging device to divide the beam from the image splitter into a plurality of divided beams and to direct the plurality of divided beams into one of a plurality of the optical imaging device.

13. The display system according to claim 1 being a rear projection based display device.

14. A projecting system for projecting a plurality of images included in a beam onto a screen, comprising:
a beam source providing the beam;
an image splitter disposed in proximity to the beam source and has a positive magnifying ratio; and
an imaging device disposed in proximity to the image splitter, wherein the beam passes through the image splitter and the imaging device to be projected onto the screen.

15. The projecting system according to claim 14, wherein the image splitter has a first optical axis and the image device has a second axis free from being coaxial with the first optical axis.

16. The projecting system according to claim 14, wherein the beam source further includes a light source providing a light, a light integration rod having a light entering end and a light exiting end and a light valve, and the light source, the light integration rod and the light valve are such configured that the light emitted from the light source passes through the light integration rod by entering it from the light entering end and exiting it from the light exiting end and propagates to the light valve to form the beam.

17. The projecting system according to claim 16, wherein the light integration rod is functioned to integrate and uniform the light and to cause the light to be in an elliptic optical angle so that the beam entering into the image splitter has a relatively small optical angle, and the light valve is one selected from a group consisting of a digital micro-mirror display chip, a liquid-crystal-on-silicon chip and a transmissive liquid crystal display chip and is functioned as a light processing unit to process the plurality of images to be associated with the light in cooperation with the light source and the integration rod so as to form the beam including the plurality of images.

18. The projecting system according to claim 14, wherein the image splitter further includes a first lens group at a beam source side thereof toward the beam source and a second lens group at a imaging device side thereof toward the imaging device.

19. The projecting system according to claim 18, wherein the first lens group is functioned to perform a first convergence of the beam and split the plurality of the images in the beam such that the plurality of the images do not overlap with each other in the beam, and the second lens group is functioned to receive the beam and perform a second convergence of the beam.

20. A projecting system for projecting a plurality of images included in a beam from a beam source onto a screen, comprising:
an image splitter configured between the beam source and the screen and having a positive magnification.
